(19) United States
(12) Patent Application Publication
(10) Pub. No.: US 2025/0296565 A1
(43) Pub. Date: Sep. 25, 2025

(54) CONTROL SYSTEM FOR A VEHICLE AND METHOD

(71) Applicant: JAGUAR LAND ROVER LIMITED, Warwickshire (GB)

(72) Inventors: Usmaan JAVED, Whitley, Coventry, Warwickshire (GB); John BEATY, Whitley, Coventry, Warwickshire (GB)

(21) Appl. No.: 18/863,696

(22) PCT Filed: May 5, 2023
(86) PCT No.: PCT/EP2023/062014

§ 371 Date: Nov. 7, 2024

(30) Foreign Application Priority Data
May 10, 2022 (GB) 2206819.1

(51) Int. Cl. B60W 30/14

(52) U.S. Cl. CPC B60W 30/146; B60W 2510/22; B60W 2520/10; B60W 2520/22; B60W 2720/10

(57) ABSTRACT

Aspects of the present invention relate to a speed control system (15) for a vehicle (10), to a method and to a vehicle (10). An aspect relates to an off-road speed control system (15). The system (15) causes the vehicle (10) to drive at a target speed value. The system (15) receives ride height information indicative of a ride height setting of a suspension of the vehicle (10), and sets a maximum vehicle speed limit in dependence at least in part on the ride height information.

### TECHNICAL FIELD

The present disclosure relates to a control system for a vehicle and method. Aspects of the invention relate to a speed control system for a vehicle, a system for controlling a speed of a vehicle, a vehicle, a method of controlling a speed of a vehicle and a non-transitory, computer-readable storage medium.

The content of WO2013/124321 is hereby incorporated by reference.

### BACKGROUND

It is known to provide a speed control system for a vehicle, in particular a speed control system for causing a vehicle to operate in accordance with a target speed value. It is desirable to provide an improved speed control system for assisting a driver negotiate terrain with obstacles such as rocks, boulders, or other obstacles presenting an abrupt change in driving surface height that must be negotiated.

It is an aim of the present invention to address one or more of the disadvantages associated with the prior art.

### SUMMARY OF THE INVENTION

Aspects and embodiments of the invention provide a speed control system, a system for controlling a speed of a vehicle, a vehicle and a method of controlling a speed of a vehicle as claimed in the appended claims

According to an aspect of the present invention there is provided an off-road speed control system for a vehicle, the speed control system configured to cause the vehicle to operate in accordance with a target speed value, the speed control system comprising one or more controllers, the speed control system configured to:
receive ride height information indicative of a ride height setting of a suspension of the vehicle; and
set a maximum vehicle speed limit in dependence at least in part on the ride height information.

Embodiments of the invention have the advantage that vehicle composure and driver comfort may be enhanced. This is because an amount of available travel of a suspension of the vehicle is dependent on vehicle ride-height setting. By limiting vehicle speed in dependence on ride-height information, a reduction in vehicle noise, vibration and harshness may be enjoyed. This is at least in part due to a reduced probability that the suspension reaches the limit of travel whilst travelling over terrain. It is to be understood that the maximum vehicle speed limit may be lower for lower values of vehicle ride height.

In some embodiments, a reduction in wear may be enjoyed in the event that an amount of travel of the suspension of the vehicle is prevented from reaching the limit of travel.

The ride height information may comprise i) a signal indicative of a predetermined ride height setting of an electronically adjustable suspension system of the vehicle, or ii) a signal indicative of a difference in ride height between a measured ride height and a reference ride height provided by a passive suspension system of the vehicle.

Optionally, the speed control system is configured to receive articulation information indicative of an amount of articulation of front and rear wheels of the vehicle; and
set a maximum vehicle speed limit, CA_set-speed, in further dependence at least in part on the articulation information.

It is to be understood that reference to front and rear wheels is reference to front and rear wheels that support the vehicle on terrain.

The value of CA_set-speed may be lower for higher amounts of articulation of the front and rear wheels of the vehicle.

The value of CA_set_speed may be lower for lower values of vehicle ride height.

Optionally, the speed control system is configured to:
determine, based on the articulation information, a cross-articulation value indicative of an amount of cross-articulation of the wheels of the vehicle; and
set a maximum vehicle speed limit, CA_set-speed, in dependence at least in part on the cross-articulation value.

Optionally, the value of CA_set-speed is lower for higher values of cross-articulation value, CrossArtc_L.

Optionally, the value of CA_set_speed is lower for lower values of vehicle ride height.

Optionally, the cross-articulation value is dependent on:
a first articulation value indicative of an extent to which the wheels of a first diagonal wheel pair are articulated in a positive or negative direction with respect to a baseline value, and the extent to which the wheels are articulated in phase with one another;
a second articulation value indicative of an extent to which the wheels of a second diagonal wheel pair different from the first are articulated in a positive or negative direction with respect to a baseline value, and the extent to which the wheels are articulated in phase with one another; and
an extent to which the first and second articulation values correspond to antiphase movement of respective pairs with respect to one another.

It is to be understood that the cross-articulation value is a measure of the extent of cross-articulation of a first and second pair of wheels, wherein the second pair is spaced from the first pair along a longitudinal axis of the vehicle. The cross-articulation value is dependent on:
a first articulation value indicative of an extent to which the wheels of a first diagonal wheel pair are articulated in a positive or negative direction with respect to a baseline value, and the extent to which the wheels are articulated in phase with one another;
a second articulation value indicative of an extent to which the wheels of a second diagonal wheel pair different from the first are articulated in a positive or negative direction with respect to a baseline value, and the extent to which the wheels are articulated in phase with one another; and
an extent to which the first and second articulation values correspond to antiphase movement of respective pairs with respect to one another.

Optionally, the cross-articulation value, CrossArtc_L, is calculated according to the formula:

CrossArtc_L=abs(FL−FR)+abs(RL−RR)+abs(FL−RL)+abs(FR−RR)−abs(FL−RR)−abs(FR−RL)
where FL is the front left suspension height, FR is the front right suspension height, RL is the rear left suspension height and RR is the rear right suspension height.

Optionally, the speed control system is configured to receive a signal indicative of vehicle speed, VREF, the speed control system being configured to limit vehicle speed in further dependence on the value of VREF.

In a further aspect of the invention there is provided a system for controlling a speed of a vehicle comprising:
an off-road speed control system according to a preceding aspect; and
one or more sensors configured to output information indicative of an amount of articulation of front and rear wheels of the vehicle.

In some embodiments the one or more sensors may comprise an accelerometer or a gyroscope. Other suitable sensors are known to the skilled person and may be utilised in further embodiments.

In a still further aspect of the invention there is provided vehicle comprising the off-road speed control system of a preceding aspect or the system of a preceding aspect.

In another aspect of the invention there is provided a method of controlling a speed of a vehicle implemented by an off-road speed control system, comprising:
causing the vehicle to operate in accordance with a target speed value;
receiving ride-height information indicative of a ride-height setting of a suspension of the vehicle; and
setting a maximum vehicle speed limit in dependence at least in part on the ride-height information.

The ride height information may comprise i) a signal indicative of a predetermined ride height setting of an electronically adjustable suspension system of the vehicle, or ii) a signal indicative of a difference in ride height between a measured ride height and a reference ride height provided by a passive suspension system of the vehicle.

Optionally, the method comprises:
receiving articulation information indicative of an amount of articulation of front and rear wheels of the vehicle; and
setting the maximum vehicle speed limit in further dependence at least in part on the articulation information.

Optionally, the method comprises:
determining, based on the articulation information, a cross-articulation value indicative of an amount of cross-articulation of the wheels of the vehicle; and
setting the maximum vehicle speed limit, CA_set-speed, in dependence at least in part on the cross-articulation value.

Optionally, the method comprises:
setting the value of CA_set-speed to a lower value as a function of higher values of cross-articulation value, CrossArtc_L; and
setting the value of CA_set_speed to a lower value as a function of lower values of vehicle ride height.

In still another aspect of the invention there is provided a non-transitory, computer-readable storage medium storing instructions thereon that, when executed by one or more electronic processors, causes the one or more electronic processors to carry out the method of a preceding aspect.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic representation of a vehicle having a speed control system according to an embodiment of the invention;

FIG. 2 shows a schematic representation of a steering wheel of a vehicle having a speed control system according to an embodiment of the invention;

FIG. 3 shows a schematic representation of a vehicle control unit or system (VCU) according to an embodiment of the invention;

FIG. 4 is a schematic illustration of a variation of the value of CA_set_speed as a function of VREF and S_comfort for a vehicle having the VCU of FIG. 3;

FIG. 5 shows a schematic representation of a VCU according to an embodiment of the invention;

FIG. 6 is a schematic illustration showing an expected variation in vehicle speed VREF as a function of time following triggering of a reduction in the value of CA_set_speed after a vehicle having the VCU of FIG. 5 encountered a bump in a driving surface sufficient to trigger a reduction in vehicle speed, the graph showing the reduction in speed for the vehicle with a ride height setting of (a) off-road height, (b) normal on-road height and (c) access height;

FIG. 7 illustrates the manner of operation of a VCU of the embodiment of FIG. 5; and

FIG. 8 is a schematic illustration of (a) an electronic controller 15′ comprised by the VCU of the embodiment of FIG. 3 and configured to implement a speed control system according to the embodiment of FIG. 3; and (b) an electronic controller comprised by the VCU of the embodiment of FIG. 5 and configured to implement a speed control system according to the embodiment of FIG. 5.

### DETAILED DESCRIPTION

The content of WO2013/124321 is hereby incorporated by reference.

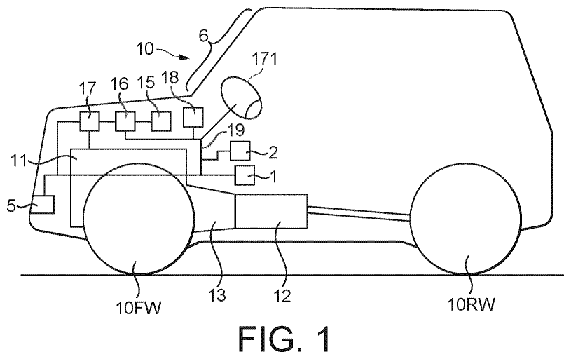

FIG. 1 is a schematic illustration of a vehicle 10 according to an embodiment of the present invention. The vehicle 10 has a prime mover or motor 11 in the form of an internal combustion engine. The engine 11 is coupled to a transmission 12 by means of a coupling 13. The coupling 13 is arranged to allow the transmission 12 progressively to reach a speed compatible with motor speed when the vehicle 10 is accelerated from rest. The coupling 13 is typically a friction clutch, torque converter or the like. The transmission 12 is arranged to drive a pair of rear wheels 10RW and optionally a pair of steerable front wheels 10FW in addition. An accelerator pedal 1 allows a driver to control an amount of torque developed by the motor 11 under the control of a powertrain controller 17 whilst a brake pedal 2 allows a driver to apply a braking system under the control of a brake controller 16. A driving mode selector 19 is provided by means of which a driver may select an on-road driving mode or one of a plurality of off-road driving modes which include a grass/gravel/snow (GGS) driving mode, sand (S) driving mode and a mud and ruts (MR) driving mode. In some embodiments the selector also allows an ‘automatic response mode’ to be selected in which the vehicle 10 determines automatically the optimum driving mode at any given moment in time. The driving modes may be referred to as “terrain response” (or “TR”) modes or TRmode or TR mode.

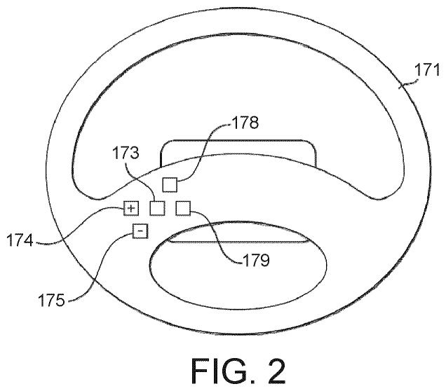

The vehicle 10 has a vehicle control unit (VCU) 15 that is operable to implement a low-speed vehicle speed control function or system. The low-speed vehicle speed control function may also be referred to as an ‘off-road’ or ‘off-highway’ cruise control function or system. The low-speed vehicle speed control function is operable provided vehicle speed VREF does not exceed a predetermined maximum speed. In the present embodiment the predetermined maximum speed is 30 km/h. Above 30 km/h the VCU 15 is operable to implement a higher-speed speed control function or system. The VCU 15 may be described as implementing a low-speed speed control system or a higher-speed speed control system. Both the low-speed speed control system and higher-speed speed control system functionality is controlled by a user by means of input controls mounted to a steering wheel 171 of the vehicle 10. The steering wheel 171 is shown in more detail in FIG. 2. It is to be understood that the low-speed vehicle speed control function or system may be useful when driving in off-highway driving conditions whilst the higher-speed speed control function or system may be useful when driving in on-highway driving conditions such as on a relatively smooth, dry tarmac or concrete driving surface.

The input controls include a ‘set-speed’ control 173, actuation of which sets the value of a parameter driver_set_speed to be substantially equal to the current vehicle speed. Depression of a ‘+’ (or ‘plus’) button 174 allows the set-speed to be increased whilst depression of a ‘-’ (or ‘minus’) button 175 allows the set-speed to be decreased. In some embodiments, if the speed control function is not active when the ‘+’ button 174 is depressed, the speed control function is activated.

In the present embodiment, the VCU 15 is configured to implement an active speed control system (or ‘active cruise control’) when the higher-speed speed control system is operating. The active speed control system is configured to cause the vehicle 10 to maintain a predetermined distance behind a lead vehicle in certain situations as will be explained. The wheel 171 also has a pair of following distance control buttons 178, 179 for setting a value of a parameter distance_following, being the distance the driver desires the vehicle 10 to maintain behind the lead vehicle. The VCU 15 is operable to control the vehicle 10 to maintain a distance behind a lead vehicle that is substantially equal to a distance represented by a parameter distance_following. A first of the buttons 178 is operable to increase the value of the parameter distance_following, and therefore the distance between the vehicle 10 and the lead vehicle, whilst a second of the buttons 179 is operable to decrease the value of the parameter distance_following. The vehicle 10 has a radar module 5 mounted to a front thereof and arranged to project a radar beam in a direction ahead of the vehicle 10. The module 5 is arranged to detect radiation reflected by a lead vehicle and to determine a distance of the lead vehicle from vehicle 10 (being a ‘host’ vehicle). The module 5 is provided with a signal indicative of a current speed of the host vehicle 10. From this signal and data in respect of a variation in distance of the lead vehicle from the host vehicle 10 as a function of time, the module 5 is able to calculate a speed of the lead vehicle. Other arrangements for determining distance from the lead vehicle and speed of the lead vehicle are also useful. In some embodiments, active speed control functionality is not provided and the following distance control buttons 178, 179 are omitted. In some embodiments, the radar module 5 is omitted.

The higher-speed speed control system is not the subject of the present application. The remainder of the present description relates to the low-speed speed control system unless otherwise stated.

When the low-speed speed control system is activated, the VCU 15 controls the speed of the vehicle 10 in accordance with a target speed value which is set substantially equal to a driver selected set-speed, driver_set_speed, or a lower value if this is desirable as described in more detail below. The VCU 15 does this by calculating a maximum allowable speed of the vehicle 10 at a given moment in time, max_set_speed. The VCU 15 sets the value of max_set_speed to the value of driver set-speed, driver_set_speed, unless a lower value is desirable as described in more detail below. The VCU 15 controls the speed of the vehicle 10 in accordance with max_set-speed, being a target speed value for the vehicle, by causing vehicle speed VREF to be equal to the value of max_set_speed.

The VCU 15 then outputs to the powertrain controller 17 and brake controller 16 a target value of acceleration at a given moment in time, acc_tgt, in order to cause vehicle speed, as determined by reference to the vehicle reference speed VREF, to maintain the desired value. If the driver over-rides the speed control system and VREF exceeds 30 km/h, the speed control system suspends operation until VREF falls to 30 km/h or less.

The driver may set the value of driver_set_speed of the low-speed speed control system to the current vehicle speed, VREF (provided VREF does not exceed 30 km/h), by depressing the ‘set-speed’ control 173 whilst the vehicle 10 is travelling. When the VCU 15 detects that the ‘set-speed’ control 173 has been pressed, the VCU 15 takes a snapshot of the current speed of the vehicle 10, VREF, and sets the value of driver_set_speed to correspond to the current speed. (It is to be understood that, if VREF exceeds 30 km/h and the set-speed control 173 is pressed, the higher-speed speed control system is activated. In the present embodiment the low-speed speed control system will not automatically reactivate once the speed falls below 30 km/h if the higher-speed speed control system has been activated since the value of driver_set_speed has been set to a value exceeding 30 km/h).

As described above, when the vehicle 10 is travelling along a road and the higher-speed speed control system is active, i.e. VREF and driver_set_speed exceed a minimum allowable set-speed set_speed_min, in the present embodiment 30 km/h, the VCU 15 is operable to allow the user to command the VCU 15 to maintain the current vehicle speed by depressing set-speed control 173. In the absence of traffic ahead of the vehicle 10 or other factors requiring a lower speed (see below), the VCU 15 controls the speed of the vehicle 10 VREF to maintain VREF substantially equal to the set-speed value driver_set_speed.

In the present embodiment, if the VCU 15 detects (by means of radar module 5) the presence of a lead vehicle ahead of the vehicle 10, the VCU 15 is operable to reduce the speed of the host vehicle 10 according to the speed of the lead vehicle in order to maintain a distance behind the lead vehicle that is no less than a prescribed distance. The prescribed distance may be set by a driver by means of ‘following distance’ control buttons 178, 179 as noted above. This function is only available in the higher-speed speed control system is active.

The vehicle 10 has a human machine interface (HMI) in the form of a touchscreen 18 by means of which the VCU 15 may communicate with a user. As described above, when the low-speed speed control system is active, the VCU 15 is operable to calculate a maximum allowable value of set-speed, max_set_speed, in dependence on the terrain over which the vehicle is travelling. The VCU 15 is operable to calculate the maximum allowable value of set-speed, max_set_speed, by means of ‘max set speed calculation’ portion (or ‘engine’) 15a. Thus, the VCU 15 is operable to limit the maximum speed at which it will control a vehicle 10 to operate in dependence on the terrain. Embodiments of the invention allow improved vehicle composure when operating in off-highway conditions with reduced driver intervention. That is, because the VCU 15 determines the maximum allowable value max_set_speed of the set-speed and limits the set-speed accordingly, a driver is not required to intervene in order to reduce the value of vehicle set-speed when the prevailing terrain so warrants, and to increase the set-speed when the prevailing terrain allows.

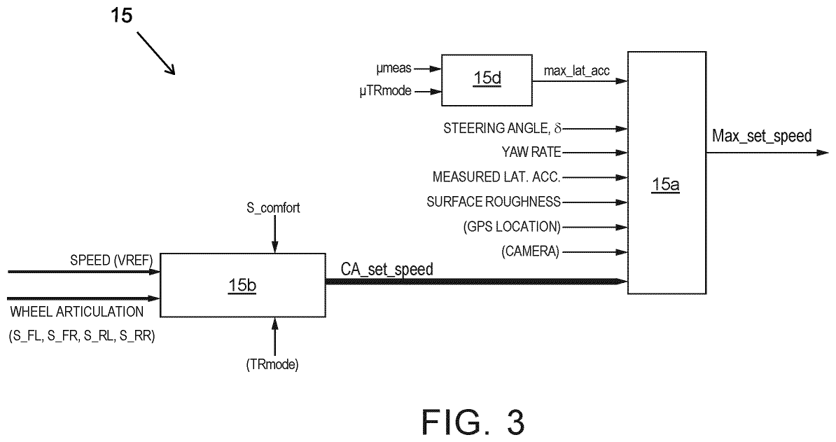

FIG. 3 illustrates a manner in which the VCU 15 determines a value of max_set_speed. As noted above the VCU 15 includes a ‘max set speed calculation’ portion (or ‘engine’) 15a. It also includes a ‘max cross-articulation (CA) set-speed calculation’ module (or ‘engine’) 15b (also referred to as the ‘cross articulation module’ 15b). Additionally, an input to the ‘max set speed calculation’ portion (or ‘engine’) comprises a ‘lateral acceleration limit calculation’ portion 15d.

The ‘max set speed calculation’ portion 15a of the VCU 15 is configured to receive inputs corresponding to a number of vehicle parameters in addition to the current value of driver_set_speed. As described above, the ‘max set speed calculation’ portion 15a outputs a value of max_set_speed that is no greater than the value of driver_set_speed but may be lower if the ‘max set speed calculation’ portion 15a determines that driving conditions so demand, as described in further detail below. The parameters are: (a) a current vehicle reference value of surface coefficient of friction, μmeas, being a value calculated by the VCU 15 based on values of one or more parameters such as an amount of torque applied to a wheel at which excessive wheel slip was induced; (b) a value of expected surface coefficient of friction corresponding to a currently selected vehicle driving mode, μTRmode, being a prescribed value for each driving mode; (c) a current value of steering angle, corresponding to a steerable road wheel angle or steering wheel position ‘STEERING ANGLE,’; (d) a current yaw rate of the vehicle (determined by reference to an output of an accelerometer), ‘YAW RATE’; (e) a current measured value of lateral acceleration, ‘MEASURED LAT.ACC.’, (also determined by reference to an output of an accelerometer); and (f) a current measured value of surface roughness, ‘SURFACE ROUGHNESS’, (determined by reference to suspension articulation). In some embodiments, the VCU 15 may also receive (g) a signal indicative of a current location of the vehicle, ‘GPS LOCATION’, (determined by reference to a global satellite positioning system (GPS) output or other global navigation satellite systems or other positioning systems); and (h) information obtained by means of a camera system, ‘CAMERA’. The information obtained by means of a camera system or imaging system may include for example an alert in the event that it is determined that the vehicle 10 may be about to depart from an off-road lane or track.

The ‘lateral acceleration limit calculation’ portion 15d of the VCU 15 is configured to determine, from the reference value of surface coefficient of friction, μmeas, and expected value of surface coefficient of friction, μTRmode, a maximum allowable rate of lateral acceleration max_lat_acc of the vehicle 10 during the course of a journey. The VCU 15 employs this value of max_lat_acc to limit the value of max_set_speed when the vehicle is cornering, so as to prevent understeer.

In the present embodiment the ‘max set speed calculation’ portion 15a of the VCU 15 is also operable to calculate a radius of curvature of a path of the vehicle 10 over terrain based on steering angle. The VCU 15 compares this radius of curvature with the vehicle yaw rate and measured lateral acceleration. If the VCU 15 detects the presence of understeer the VCU 15 is operable to reduce the value of max_set_speed accordingly, by means of the ‘max set speed calculation’ portion 15a. In some embodiments where a signal indicative of a current location of the vehicle is received, the VCU 15 may also take into account a path of travel of the vehicle determined by reference to location signal in order to increase a reliability of the determination of the amount of understeer present, if any.

In some embodiments, yaw rate and measured lateral acceleration are not employed in determining the amount of understeer present. Other arrangements are also useful.

The VCU 15 also determines the value of max_set_speed according to a value of surface roughness of the terrain over which the vehicle 10 is driving. The value of max_set_speed may be reduced as the surface roughness increases.

The ‘max cross-articulation (CA) set-speed calculation’ module 15b configured to calculate a maximum value of allowable vehicle speed based on the amount of cross-articulation of the vehicle suspension at a given moment in time.

In the embodiment illustrated, the module 15b receives the following signals:
a vehicle reference speed signal VREF indicative of a speed of the vehicle over ground;
articulation information in the form of wheel articulation signals S_FL, S_FR, S_RL, S_RR, where S_FL is a signal indicative of the front left suspension height FL, S_FR is a signal indicative of the front right suspension height FR, S_RL is a signal indicative of the rear left suspension height RL and S_RR is a signal indicative of the rear right suspension height indicative RR.

The wheel articulation signals are received from respective wheel articulation sensors associated with respective wheels of the vehicle. Each wheel articulation sensor is arranged to output a respective wheel articulation signal indicative of the height of the suspension associated with the wheel corresponding to that sensor. In some embodiments more than one wheel articulation sensor may be associated with each wheel, or at least one of the wheels. In some embodiments, the module 15b may, in addition, receive one or both of the following signals:
a signal TRmode indicative of the driving mode (TR mode) in which the vehicle is currently operating; and
a comfort signal S_comfort indicative of a level of comfort required by an occupant of the vehicle (see below).

In an embodiment, the cross-articulation value is dependent on a first articulation value indicative of an extent to which the wheels of a first diagonal wheel pair are articulated in a positive or negative direction with respect to a baseline value. For example, the front left wheel and rear right wheel may be considered to form a first diagonal wheel pair. A baseline value, which in some embodiments may be zero, is set by the speed control system, and the articulation of the first diagonal wheel pair with respect to said baseline value is given a value. The value of articulation of the diagonal wheel pair may be considered positive when the front left wheel is higher than the rear right wheel of the first diagonal wheel pair. The value of articulation of the first diagonal wheel pair may be considered negative when the front left wheel is lower than the rear right wheel of the diagonal wheel pair. It will be understood that in other embodiments the positive and negative direction may be reversed, and/or the baseline may be set differently.

In an embodiment, the cross-articulation value is dependent on the extent to which the wheels are articulated in phase with one another. For example the first diagonal wheel pair comprising the front left wheel and the rear right wheel may be considered in phase if both the front left wheel and the rear right wheel are in a maximum compression scenario, that is the front left suspension height signal indicates that the front left suspension is in the highest position and the rear right suspension height signal indicates that the rear right suspension is also in the highest position. Alternatively, the first diagonal wheel pair comprising the front left wheel and the rear right wheel may be considered in phase if both the front left wheel and the rear right wheel are in a maximum extension scenario, that is the front left suspension height signal indicates that the front left suspension is in the lowest position and the rear right suspension height signal indicates that the rear right suspension is also in the lowest position.

In an embodiment, the cross-articulation value is dependent on a second articulation value indicative of an extent to which the wheels of a second diagonal wheel pair different from the first are articulated in a positive or negative direction with respect to a baseline value. For example, if the first articulation value relates to a first diagonal wheel comprising the front left wheel and rear right wheel, the second articulation value is dependent on a second diagonal wheel pair comprising the front right wheel and the rear left wheel. The value of articulation for the second diagonal wheel pair may be calculated in the same way as the value of articulation for the first diagonal wheel pair.

In an embodiment, the extent to which the wheels of the second diagonal wheel pair are articulated in phase is understood to be calculated in the same way as the extent to which the first diagonal wheel pair are articulated in phase, as discussed previously.

In an embodiment, the cross-articulation value is dependent on the extent to which the first and second articulation values correspond to antiphase movement of respective pairs with respect to one another. A maximum antiphase position of the first diagonal wheel pair and the second diagonal wheel pair would occur when the first diagonal wheel pair are in a maximum compression scenario, as discussed earlier and the second diagonal wheel pair are in a maximum extension scenario, as discussed earlier. It will be understood that antiphase need not mean this maximum position, but any position where the diagonal wheel pairs are in opposition.

The amount of cross-articulation of the vehicle suspension, CrossArtc_L, is calculated by the module 15b from the articulation information according to the following formula:

$$CrossArtc\_L = abs ( FL - FR ) + abs ( RL - RR ) + abs ( FL - RL ) + abs ( FR - RR ) - abs ( FL - RR ) - abs ( FR - RL )$$

where FL is the front left suspension height, FR is the front right suspension height, RL is the rear left suspension height and RR is the rear right suspension height, the suspension heights being with respect to a reference height. In the present embodiment, the reference height (or ‘datum’ position) is a position midway between the extremes of upper and lower movement of each wheel. It is to be understood that other datum positions may be employed without affecting the value of CrossArtc_L.

As noted above, in some embodiments of the present invention, the cross-articulation module 15b of the VCU 15 is configured to receive a comfort signal S_comfort indicative of a desired comfort setting, being an indication of a desired level of occupant comfort. The comfort setting may be adjusted by a user via touchscreen 18, although other input devices may be useful such as a rotary dial. In some embodiments, the comfort signal S_comfort indicates whether the comfort setting has a value of 0 (zero), 1, 2, 3 or 4. A value of zero is considered to correspond to an ‘off’ condition of the comfort setting, indicating that no account is to be taken of passenger comfort when setting the value of CA_set_speed.

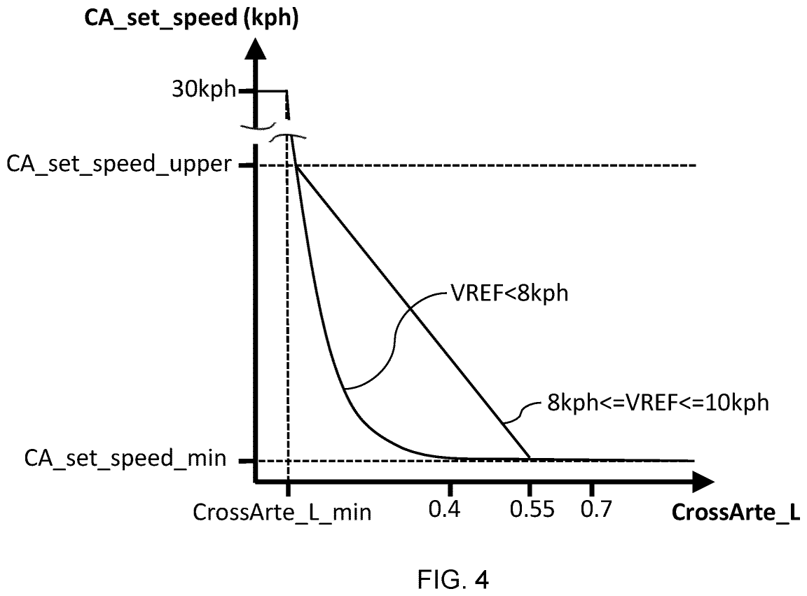

In the present embodiment, the cross-articulation module 15b determines a value of CA_set_speed based on the values of vehicle reference speed VREF, wheel cross-articulation value CrossArtc_L and TRmode. FIG. 4 illustrates schematically the variation in value of CA_set_speed as a function of VREF and CrossArtc_L.

If the value of VREF is in the range 8≤VREF≤10 km/h and the amount of cross-articulation of the vehicle suspension, CrossArtc_L, exceeds a minimum value CrossArtc_L_min, the value of CA_set_speed is set to a value that decreases from an upper allowable value, CA_set_speed_upper, to a minimum allowable value, CA_set_speed_min, in a substantially linear manner as a function of increasing values of CrossArtc_L. In the present embodiment, the value of CrossArtc_L_min is set to a value of 0.03, although other values may be useful.

If the value of VREF is less than 8 km/h, i.e., VREF<8 km/h, and the amount of cross-articulation of the vehicle suspension, CrossArtc_L, exceeds the minimum value CrossArt_L_min, the value of CA_set_speed is set to a value that decreases from the upper allowable value, CA_set_speed_upper, to the minimum allowable value, CA_set_speed_min, in a more aggressive or abrupt manner, as a function of increasing values of CrossArtc_L, than when the value of VREF is in the range 8≤VREF≤10 km/h. In the present embodiment the cross-articulation module 15b is configured such that the value of CA_set_speed decreases in a substantially exponential manner, the rate at which CA_set_speed decreases itself decreasing as a function of increasing amount of cross-articulation of the vehicle suspension.

In the present embodiment, the articulation module 15b is configured such that the value of CA_set_speed_upper is 10 km/h whilst the value of CA_set_speed_min is 1.8 km/h. Other values of CA_set_speed_upper and CA_set_speed_min may be useful in some embodiments.

In the present embodiment, if the value of VREF exceeds a predetermined upper limit value, in the present embodiment 10 km/h, the value of CA_set_speed is set to a value corresponding to the maximum allowable value of max_set_speed such that the value of max_set_speed is not affected by the value of CA_set_speed. This is at least in part because if a vehicle is travelling at a speed exceeding 10 km/h, it is considered to be unlikely that the vehicle 10 is negotiating rocky terrain. Accordingly, any excursion of the value of CrossArtc_L above the minimum value, CrossArtc_L_min, above which the VCU 15 intervenes to limit vehicle speed, is likely to be transient and potentially due to wheel bounce rather than due to the presence of rocky terrain. Other values of predetermined upper limit value may be useful in some embodiments such as 12 km/h, 9 km/h, or any other suitable value.

In some embodiments, the speed control system is inoperable above a predetermined speed control system inoperable value. The predetermined upper limit value is less than the predetermined speed control system inoperable value. The system inoperable value refers to where the maximum allowable value of max_set_speed is 30 km/h although other values may be useful in some embodiments.

In some embodiments, when the condition is met that the value of VREF is in the range 8≤VREF≤10 km/h, the value of CA_set_speed may decrease more steeply as a function of CrossArtc_L with increasing values of comfort parameter. In some embodiments the value of CA_set_speed may decrease as a function of comfort parameter for values of comfort parameter of 2 or more. Thus, in some embodiment, the value of CA_set_speed may increasing more steeply as a function of CrossArtc_L as the comfort setting increases from a value of 2 to a value of 4.

It is to be understood that the VCU 15 maintains a lower value of CA_set_speed in response to increasing values of CrossArtc_L for as long as the car is traveling over a suitably articulated surface. Once the car leaves the articulated surface and the value of CrossArtc_L reduces, the VCU 15 increases the value of CA_set_speed back to the maximum allowable value of vehicle set-speed, i.e. 30 km/h in the present embodiment. It is to be understood that the VCU 15 limits the rate at which the value of CA_set_speed is increased in order to avoid excessive jerk.

As noted above, in some embodiments, the cross-articulation module 15b may also take into account the driving mode in which the vehicle 10 is operating, as determined by reference to the TRmode signal, when calculating the value of CA_set_speed. The value of CA_set_speed may be lower for higher desired values of occupant comfort.

In the present embodiment, the cross-articulation module 15b is implemented in software run by the VCU 15. In some embodiments, the module 15b may be a separate, dedicated electronic module having a processor associated therewith and arranged to output a signal indicative of the value of CA_set_speed.

### Ride Height

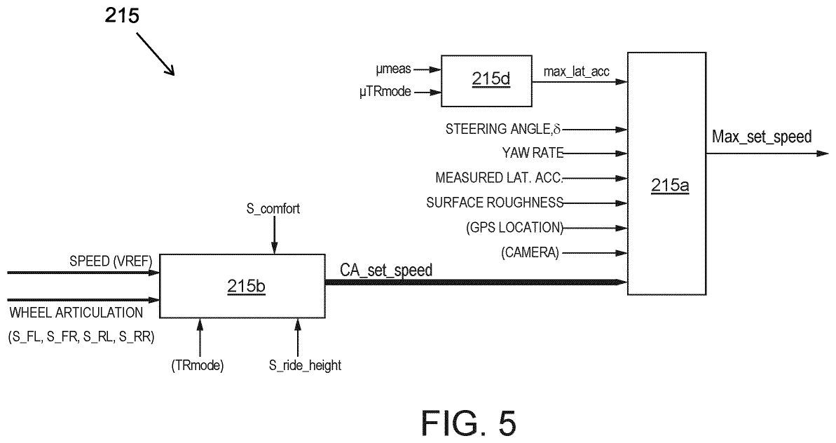

FIG. 5 illustrates a configuration of a VCU 215 according to a further embodiment of the present invention. Like features of the embodiment of FIG. 5 to the embodiment of FIG. 3 are shown with like reference numerals incremented by 200. In the embodiment illustrated, the cross-articulation module 215b is configured to receive a further signal, S_ride_height, providing ride height information indicative of a ride height setting of the vehicle 10. It is to be understood that, in the present embodiment, a driver is able to set a ride height of the vehicle, corresponding to a distance of an underside of the vehicle above ground when the vehicle is stationary on a flat, horizontal surface.

In the present embodiment, the VCU 215 is configured to permit the vehicle ride height to be set to one of three predetermined settings, each corresponding to a different distance between ground and a given location on the underside of the vehicle:
(a) off-road ride height;
(b) normal on-road ride height; and
(c) access ride height.

It is to be understood that the off-road ride height corresponds to a higher ride height, providing greater ground clearance, than the on-road ride height, which is in turn a higher ride height than the access ride height. The access ride height is intended to facilitate more convenient access to the vehicle, for example for the boarding and alighting of passengers or the loading and unloading of cargo.

In the embodiment of FIG. 5, the cross-articulation module 215b is configured to operate in a similar manner to the embodiment of FIG. 3 when the ride height is set to the normal on-road ride height. That is, when the ride height is set to the normal on-road ride height, the cross-articulation module 215b is configured to output a value of CA_set_speed calculated according to the plots of FIG. 4.

However, when the ride height is set to a ride height other than normal on-road ride height, the cross-articulation module 215b is configured to calculate a value of CA_set_speed corresponding to the plot of FIG. 4 but with the x-axis scaled by a predetermined scale factor, such that the value of CA_set_speed is changed for a given value of CrossArtc_L_Max relative to operation with the normal on-road ride height.

In the present embodiment, when the ride height is set to the access ride height, the cross-articulation module 215b is configured to scale the x-axis of the plot of FIG. 4 by a scale factor of 3, such that the value of CA_set_speed is reduced for a given value of CrossArtc_L_Max relative to operation with the normal on-road ride height. This is because, when the access ride height is selected, there is an increased risk that the vehicle may become grounded as it negotiates rocky terrain. Thus, a value of CrossArtc_L_Max of 0.2 in normal on-road ride height would equate to a value of 0.6 in Access Height.

It is to be understood that other values of scale factor may be useful in some embodiments, such as 0.2, 0.4, 0.6, 0.8 or any other suitable value.

In the present embodiment the minimum allowable value of CA_set_speed, CA_set_speed_min, remains at 1.8 km/h for each ride height setting. However, it is to be understood that a different value of CA_set_speed_min may be employed in some embodiments when the access ride height has been selected, such as a value of 1 km/h or any other suitable value.

In some embodiments, if the cross-articulation module 215b causes a reduction in CA_set_speed when the vehicle is travelling with the access ride height setting, the cross-articulation module 215b causes the driver to be alerted to the fact that an intervention has taken place by means of the HMI touchscreen 18. For example, the cross-articulation module 215b may be configured to cause the HMI touchscreen 18 to advise a driver to “raise the ride height of the vehicle if it is appropriate to do so”.

When the ride height is set to the off-road ride height, the cross-articulation module 215b is set to scale the x-axis of the plot of FIG. 4 by a scale factor of 0.75, such that the value of CA_set_speed is increased for a given value of CrossArtc_L_Max relative to operation with the normal on-road ride height. This is because, when the off-road ride height is selected, there is a reduced risk that the vehicle may become grounded as it negotiates rocky terrain.

Thus, a value of CrossArtc_L_Max of 0.2 in normal on-road ride height would equate to a value of 0.15 in off-road height. It is to be understood that other values of scale factor may be useful in some embodiments, such as 0.5, 0.25 or any other suitable value.

As noted above, in the present embodiment the minimum allowable value of CA_set_speed, CA_set_speed_min, remains at 1.8 km/h for each ride height setting. However, it is to be understood that a different value of CA_set_speed_min may be employed in some embodiments when the off-road ride height has been selected, such as a value of 4 km/h or any other suitable value.

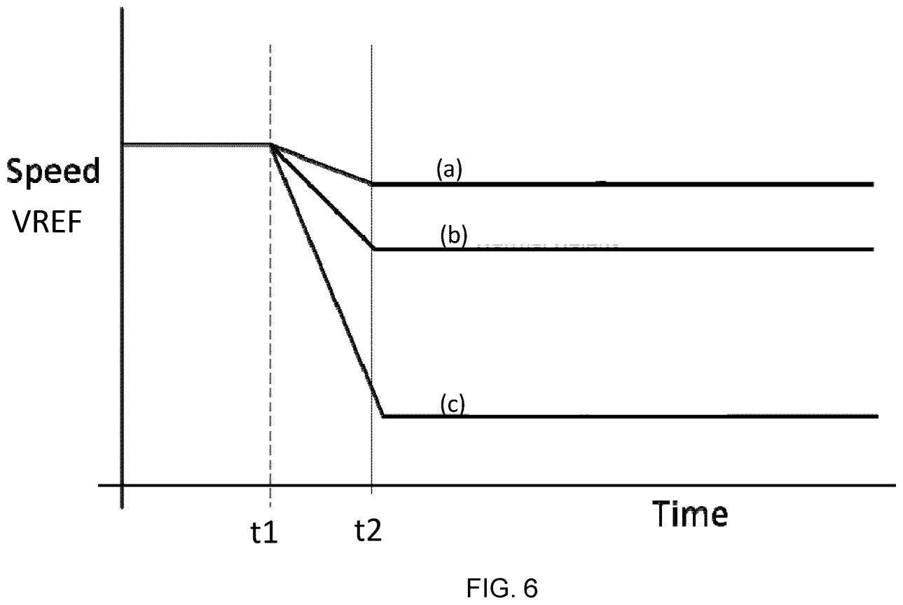

FIG. 6 is a schematic illustration showing an expected variation in vehicle speed VREF as a function of time following triggering of a reduction in the value of CA_set_speed after a vehicle having the VCU 215 of FIG. 5 encounters a bump. The graph shows vehicle speed VREF as a function of time before and after encountering a bump in a driving surface that triggers a reduction in vehicle speed due to the bump at time t1. The variation in VREF is shown for the vehicle with the three different ride height settings, being (a) off-road height, (b) normal on-road height and (c) access height. Time t2 represents the approximate time at which the new vehicle speed VREF is achieved in each of the three ride height settings (a), (b) and (c).

It can be seen from FIG. 6 the value of CA_set_speed corresponding to the off-road ride height setting is higher than that for the normal on-road ride height setting, which is in turn higher than that for the access ride height setting. As shown in FIG. 6, the difference between the value of CA_set_speed in the off-road and normal on-road ride height settings is much less than the difference between with the value of CA_set_speed in the normal on-road ride height and access ride height settings. However, the reduction in vehicle speed from the prevailing speed at time t1 to the corresponding value of CA_set_speed can be seen to be similar for each ride-height setting. This may be at least in part in order to reduce driver inconvenience due to the suspension reaching a limit of travel in an abrupt manner when travelling with each setting, in particular with the access ride height setting, where the available travel is the least.

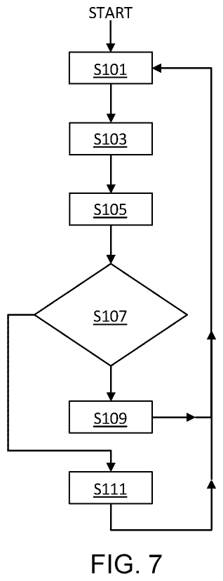

FIG. 7 illustrates the manner of operation of the VCU 215 of the embodiment of FIG. 5.

At step S101 the VCU 15 determines the value of CrossArt_L based on the wheel articulation signals received as described above.

At step S103 the VCU calculates a value of CA_set-speed in dependence on VREF, CrossArt_L and ride-height setting.

At step S105 the VCU 15 calculates a value of max_set-speed not taking CA_set-speed into account, max_set-speed’.

At step S107 the VCU 15 determines whether max_set-speed’ is less than CA_set-speed. If max_set-speed’ is less than CA_set-speed the method continues at step S109 else the method continues at step S111.

At step S109 the VCU 15 sets the value of max_set-speed to the value of max_set-speed’. The method then continues at step S101.

At step S111 the VCU sets the value of max_set-speed to the value of CA_set-speed. The method then continues at step S101.

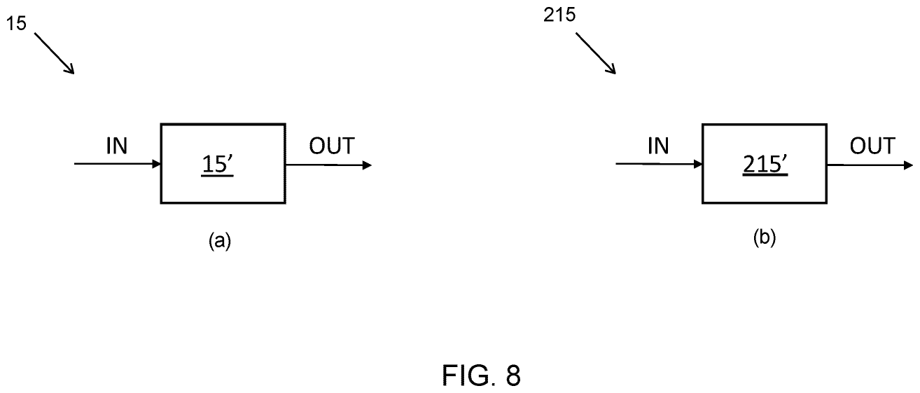

FIG. 8 is a schematic illustration of (a) an electronic controller 15′ comprised by VCU 15 and configured to implement the speed control system of the VCU 15 and (b) an electronic controller 215′ comprised by VCU 215 and configured to implement the speed control system of VCU 215.

In the embodiment of the present invention described above with reference to FIG. 5, the driver is able to set a ride height of the vehicle to one of a number of predetermined ride heights, i.e. the off-road ride height, the normal on-road ride height and the access ride height. In such an embodiment, the signal, S_ride_height, which provides ride height information may be indicative of a setting of an adjustable suspension system of the vehicle, such as an adjustable air suspension system, in which the air pressure of an adjustable air spring associated with each respective wheel of the vehicle is adjusted so as to alter the vehicle ride height, i.e. the distance between a given location on the underside of the vehicle and a point on the ground.

A further embodiment of the present invention which is suitable for use in a vehicle having a so-called passive suspension system will now be described. In a vehicle with a passive suspension system, the suspension may be provided by a coil spring and damper arrangement associated with each wheel of the vehicle. Accordingly, the height of the vehicle body with respect to the ground is determined by the weight of the vehicle body supported by the coil springs (i.e. the sprung mass of the vehicle) and the weight of any passengers and/or cargo which the vehicle is laden with. For a given vehicle, the greater the load carried, the lower the ride height of the vehicle body is with respect to the ground. This is because the springs of the passive suspension system are compressed by a greater amount as the mass of the load carried by the vehicle increases which, in turn, causes the ride height of the vehicle to reduce.

In the presently described embodiment, in which the ride height of the vehicle is set in dependence on the mass of the load being carried by the vehicle, the signal S_ride_height provides ride height information which is indicative of the ride height setting of the vehicle. In particular, the signal may be indicative of the laden vehicle ride height with respect to an unladen vehicle ride height, i.e. a nominal or reference ride height, when the vehicle is stationary on level ground. In one example, the ride height of the vehicle may be measured using a sensor or sensors disposed on the vehicle body. A sensor may be positioned proximate to each corner of the vehicle so as to measure the distance between each corner of the vehicle and the ground below each corner respectively. In this manner, a value for the measured ride height may be calculated from an average of the measurements made at each vehicle corner. In one example, the ride height measurements are only taken when it is determined that the vehicle is on substantially level ground, e.g. as determined by an inclinometer disposed on the vehicle. In this way, a more accurate determination of the laden vehicle ride height may be made. Additionally, the ride height measurements may only be taken when the vehicle is stationary, or travelling below a threshold velocity, for example at ‘key on’ prior to commencing a journey. In other embodiments, measurements may be made using sensors disposed at different locations on the vehicle body, e.g. sensors may be mounted on side mirrors of the vehicle. Additionally or alternatively, sensors may be disposed so as to measure a degree of compression of elements of the passive suspension system (e.g. a degree of compression of a coil spring) such that the ride height of the vehicle above the ground can be determined in dependence thereon, i.e. based on the difference to the degree of compression in the springs when the vehicle is unladen. Ride height measurements may be measured by sensors such as optical sensors, e.g. a camera, ultrasonic sensors, laser sensors, radar sensors or other suitable types of sensor.

It will be appreciated that various changes and modifications can be made to the present invention without departing from the scope of the present application.

1. A speed control system for a vehicle, the speed control system configured to cause the vehicle to operate in accordance with a target speed value, the speed control system comprising one or more controllers, the speed control system configured to:
receive ride height information indicative of a ride height setting of a suspension of the vehicle; and
set a maximum vehicle speed limit, CA_set-speed, in dependence at least in part on the ride height information.

2. A speed control system according to claim 1, wherein the ride height information comprises i) a signal indicative of a predetermined ride height setting of an electronically adjustable suspension system of the vehicle, or ii) a signal indicative of a difference in ride height between a measured ride height and a reference ride height provided by a passive suspension system of the vehicle.

3. A speed control system according to claim 1 further configured to receive articulation information indicative of an amount of articulation of front and rear wheels of the vehicle; and
set a maximum vehicle speed limit, CA_set-speed, in further dependence at least in part on the articulation information.

4. A speed control system according to claim 3, wherein the value of CA_set-speed is lower for higher amounts of articulation of the front and rear wheels of the vehicle.

5. A speed control system accordingly to claim 3, wherein the value of CA_set_speed is lower for lower values of vehicle ride height.

6. A speed control system according to claim 3 configured to:
determine, based on the articulation information, a cross-articulation value indicative of an amount of cross-articulation of the wheels of the vehicle; and
set a maximum vehicle speed limit, CA_set-speed, in dependence at least in part on the cross-articulation value.

7. A speed control system according to claim 6 wherein the value of CA_set-speed is lower for higher values of cross-articulation value, CrossArtc_L and/or wherein the value of CA_set_speed is lower for lower values of vehicle ride height.

8. A speed control system according to claim 6 wherein the cross-articulation value is dependent on:
a first articulation value indicative of an extent to which the wheels of a first diagonal wheel pair are articulated in a positive or negative direction with respect to a baseline value, and the extent to which the wheels are articulated in phase with one another;
a second articulation value indicative of an extent to which the wheels of a second diagonal wheel pair different from the first are articulated in a positive or negative direction with respect to a baseline value, and the extent to which the wheels are articulated in phase with one another; and
an extent to which the first and second articulation values correspond to antiphase movement of respective pairs with respect to one another, optionally wherein the cross-articulation value, CrossArtc_L, is calculated according to the formula:
$$CrossArtc\_L = abs ( FL - FR ) + abs ( RL - RR ) + abs ( FL - RL ) + abs ( FR - RR ) - abs ( FL - RR ) - abs ( FR - RL )$$
where FL is the front left suspension height, FR is the front right suspension height, RL is the rear left suspension height and RR is the rear right suspension height.

9. A speed control system according to claim 1 configured to receive a signal indicative of vehicle speed, VREF, the speed control system being configured to limit vehicle speed in further dependence on the value of VREF.

10. A system for controlling a speed of a vehicle comprising:
a speed control system as claimed in claim 1; and
one or more sensors configured to output information indicative of an amount of articulation of front and rear wheels of the vehicle.

11. A vehicle comprising the speed control system of claim 1.

12. A method of controlling a speed of a vehicle implemented by a speed control system, comprising:
causing the vehicle to operate in accordance with a target speed value;
receiving ride-height information indicative of a ride-height setting of a suspension of the vehicle; and
setting a maximum vehicle speed limit in dependence at least in part on the ride-height information.

13. A method according to claim 12, wherein the ride height information comprises i) a signal indicative of a predetermined ride height setting of an electronically adjustable suspension system of the vehicle, or ii) a signal indicative of a difference in ride height between a measured ride height and a reference ride height provided by a passive suspension system of the vehicle.

14. A method according to claim 12 further comprising:
receiving articulation information indicative of an amount of articulation of front and rear wheels of the vehicle; and
setting the maximum vehicle speed limit in further dependence at least in part on the articulation information.

15. A non-transitory, computer-readable storage medium storing instructions thereon that, when executed by one or more electronic processors, causes the one or more electronic processors to carry out the method of claim 12.
